(19) United States
(12) Patent Application Publication
(10) Pub. No.: US 2009/0025616 A1
(43) Pub. Date: Jan. 29, 2009

(54) AIR CARGO PALLETS HAVING SYNTHETIC CORES AND ASSOCIATED SYSTEMS AND METHODS FOR MANUFACTURING SAME

(75) Inventors: David T. Merrill, Scottsdale, AZ (US); Mike Ward, Tacoma, WA (US); Willard F. Hagan, Phoenix, AZ (US); Mark Breece, Anthem, AZ (US); Todd Humbert, Maricopa, AZ (US)

Correspondence Address: PERKINS COIE LLP;PATENT-SEA, P.O. BOX 1247, SEATTLE, WA, 98111-1247, US

(73) Assignee: AmSafe, Inc., Phoenix, AZ (US)

(21) Appl. No.: 11/781,881

(22) Filed: Jul. 23, 2007

(51) Int. Cl. B65D 19/38; B29C 65/00; B29C 44/34; B29C 71/02

(52) U.S. Cl. 108/57.25; 264/51; 264/236; 264/145; 264/241

(57) ABSTRACT

Air cargo pallets having polycarbonate and other polymer and synthetic cores are disclosed herein. An air cargo pallet configured in accordance with an embodiment includes a structural panel having a cargo support surface extending between opposing edge portions. The structural panel can include a polymeric core sandwiched between first and second facesheets. In one embodiment, the polymeric core can include a first piece of polymeric material attached to a second piece of polymeric material.

### TECHNICAL FIELD

The present invention is directed generally toward air cargo pallets.

### BACKGROUND

The 463L specification defines the U.S. Air Force standard for transporting cargo by air. One type of air cargo pallet that has been used in the 463L system has a balsa wood core sandwiched between two metallic facesheets. The balsa wood core provides favorable weight and strength characteristics. In use, however, the top and bottom facesheets of the air cargo pallet can be punctured. As a result, water can enter the pallet and be absorbed by the balsa wood. This has the unfavorable consequence of not only adding weight to the pallet, but also causing the balsa wood to rot which leads to delamination of the facesheets. All of these factors can reduce the structural integrity of the air cargo pallet and shorten its useful life.

Accordingly, there is a need for an air cargo pallet that is not susceptible to the aforementioned problems.

### SUMMARY

The following summary is provided for the benefit of the reader only, and is not intended to limit the invention as set forth by the claims in any way.

The present invention is directed generally toward air cargo pallets having polymer and other types of synthetic cores. An air cargo pallet configured in accordance with one aspect of the invention can include a structural panel having a cargo support surface extending between opposing edge portions. The structural panel can include a polymer core sandwiched between first and second facesheets. In this aspect of the invention, the polymer core can include a first piece of polymeric material attached to a second piece of polymeric material.

In another aspect of the invention, the first piece of polymeric material can have a plurality of first cavities extending inwardly from a plurality of corresponding first openings in a first surface of the first piece. Similarly, the second piece of polymeric material can have a plurality of second cavities extending inwardly from a plurality of corresponding second openings in a second surface of the second piece. In this aspect of the invention, the first piece of polymeric material can be adhesively bonded to the second piece of polymeric material such that the plurality of first openings is generally aligned with the plurality of second openings.

A method for manufacturing an air cargo pallet in accordance with another aspect of the invention can include positioning a first facesheet at least proximate to a frame. The method can further include positioning a polymeric core toward the first facesheet, and then positioning a second facesheet at least proximate to the polymeric core and the frame. In one aspect of this method, the polymeric core can be formed by heating and expanding polymeric sheets to form first and second pieces of polymeric material. The first and second pieces of polymeric material can then be cooled and attached together to form the polymeric core.

### BRIEF DESCRIPTION OF THE DRAWINGS

FIG. 1 is an isometric view of an air cargo pallet configured in accordance with an embodiment of the invention.

FIG. 2 is an exploded isometric view of the air cargo pallet of FIG. 1.

FIG. 3 is an enlarged, cross-sectional side view taken along line 3-3 in FIG. 1.

FIG. 4 is an enlarged isometric view of a portion of a corner of the air cargo pallet of FIG. 1.

FIG. 5 is an enlarged side view of the corner portion of FIG. 4, taken along line 5-5 in FIG. 4.

FIG. 6 is an enlarged isometric view of a corner bracket configured in accordance with an embodiment of the invention.

FIG. 7 is an enlarged top view of a piece of expanded polymeric material configured in accordance with an embodiment of the invention.

FIG. 8 is an isometric view of platens that can be used to manufacture the expanded polymeric material shown in FIG. 7.

FIG. 9 illustrates a process flow for forming expanded polymeric material in accordance with an embodiment of the invention.

FIG. 10 illustrates a process flow for forming a core panel in accordance with an embodiment of the invention.

FIG. 11 illustrates a process flow for manufacturing an air cargo pallet core in accordance with an embodiment of the invention.

FIGS. 12A-12E are a series of cross-sectional side views of air cargo pallet panels configured in accordance with other embodiments of the invention.

### DETAILED DESCRIPTION

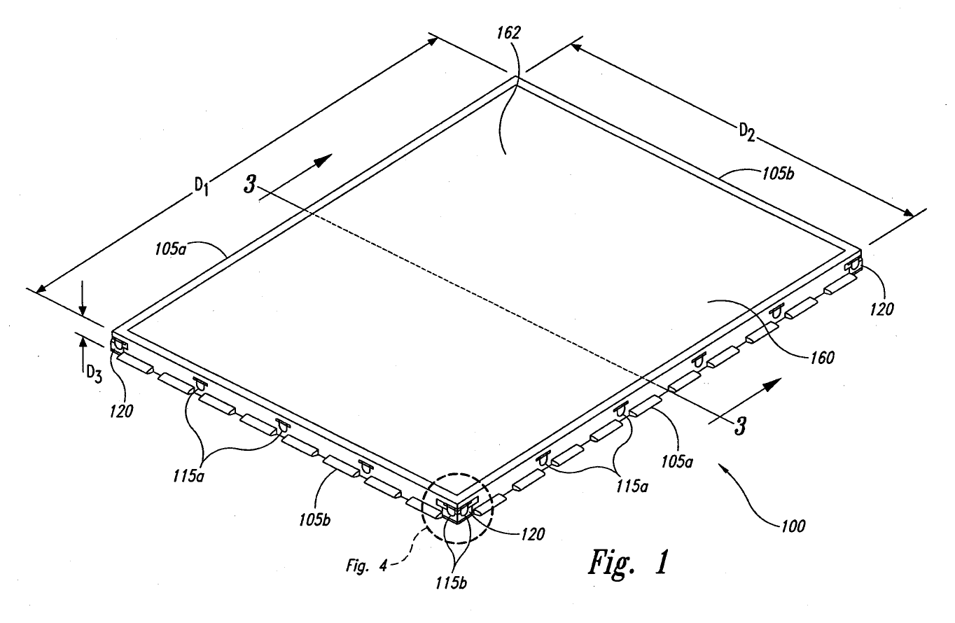

The present disclosure describes various types of air cargo pallets and associated systems and methods for manufacturing same. In one embodiment, for example, an air cargo pallet includes a structural panel having a polymeric core positioned between two facesheets. Certain details are set forth in the following description and in FIGS. 1-12E to provide a thorough understanding of various embodiments of the invention. Other details describing well-known aspects of air cargo pallets, however, are not set forth in the following disclosure to avoid unnecessarily obscuring the description of the various embodiments.

Many of the details, dimensions, angles and other features shown in the Figures are merely illustrative of particular embodiments of the invention. Accordingly, other embodiments can have other details, dimensions, angles and features without departing from the spirit or scope of the present invention. In addition, further embodiments of the invention can be practiced without several of the details described below.

In the Figures, identical reference numbers identify identical, or at least generally similar, elements. To facilitate the discussion of any particular element, the most significant digit or digits of any reference number refer to the Figure in which that element is first introduced. For example, element 100 is first introduced and discussed with reference to FIG. 1.

FIG. 1 is an isometric view of an air cargo pallet 100 configured in accordance with an embodiment of the invention. In one aspect of this embodiment, the air cargo pallet 100 (“pallet 100”) includes a structural panel 160 having a cargo support surface 162. A plurality of edge members or rails 105 (identified individually as a first rail 105a and a second rail 105b) extend around the periphery of the structural panel 160. The rails 105 can be beveled at a 45 degree angle to form miter joints at the corners. Corner brackets 120 are attached to the rails 105 at each corner of the pallet 100. A plurality of securing features 115 (for securing cargo nets, straps, etc.) can be mounted to the rails 105 or the corner brackets 120. The rails 105 can be made of aluminum, graphite/epoxy, and/or other metallic and non-metallic materials known in the art as having suitable strength, weight, cost, manufacturing, and/or other characteristics.

A length D1, a width D2, and/or a thickness D3 of the pallet 100 can be selected to accommodate various types of cargo. In an embodiment, for example, the length D1 can be from about 100 inches to about 110 inches (e.g., about 108 inches), the width D2 can be from about 80 inches to about 90 inches (e.g., about 88 inches), and the thickness D3 can be from about 1.00 inch to about 3.00 inches, (e.g., about 2.25 inches). In other embodiments, the pallet 100 can have other dimensions depending on a number of different considerations including, for example, cargo weight, aircraft size, cost, etc.

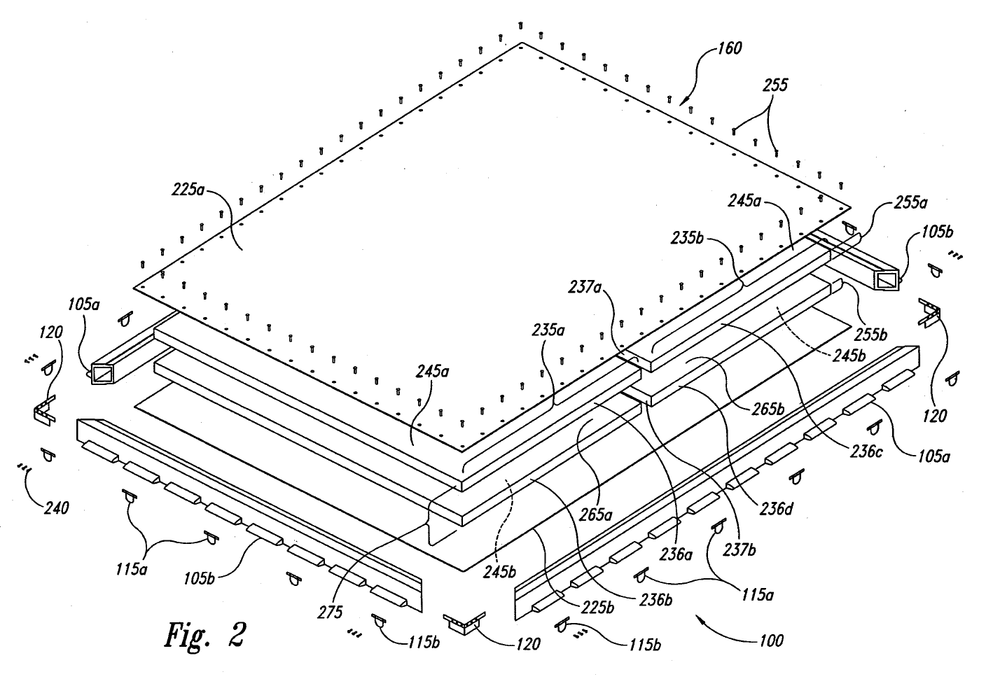

FIG. 2 is an exploded isometric view of the air cargo pallet of FIG. 1, configured in accordance with an embodiment of the invention. The structural panel 160 includes a core 275 sandwiched between a first facesheet 225a and a second facesheet 225b. The first and second facesheets 225 can be made of aluminum, graphite/epoxy, and/or other metallic and non-metallic materials known in the art as having suitable strength, weight, cost, manufacturing, and/or other characteristics.

In the illustrated embodiment, the core 275 includes a first core panel 235a and a second core panel 235b. The first core panel 235a can be composed of a first piece of expanded polymeric material 236a bonded to a second piece of expanded polymeric material 236b by an adhesive 265a. Similarly, the second core panel 235b can be composed of a third piece of expanded polymeric material 236c bonded to a fourth piece of expanded polymeric material 236d by an adhesive 265b. The first and second core panels 235 can then be bonded together along adjoining edges by an adhesive 237 (shown as a first portion of adhesive 237a and a second portion of adhesive 237b). The core 275 can be bonded to the first facesheet 225a by an adhesive 245a and to the second facesheet 225b by an adhesive 245b. The first piece of expanded polymeric material 236a and the third piece of expanded polymeric material 236c form a first core layer 255a. The second piece of expanded polymeric material 236b and the fourth piece of expanded polymeric material 236d form second core layer 255b. The adhesives 265, 245, and 237 can include, for example, a hot melt adhesive, such as EVER-LOCK® 2U453, or other suitable adhesives known in the art for bonding polymeric, synthetic and/or metallic materials.

Other configurations for the core 275 are possible. For example, the core 275 can contain more than two core panels or as few as a single core panel. As a further example, the core 275 can be composed of more than four pieces of expanded polymeric material or only a single piece of polymeric material, e.g., each core panel can be composed of more than two polymeric layers or only a single polymeric layer. As described in greater detail below, the pieces of expanded polymeric material can include a wide variety of polymer materials, including, for example, polyethylene, polypropylene, polyvinyl chloride, polyethylene terephthalate, polystyrene and polycarbonate. In other embodiments, other synthetic materials having suitable weight, strength, cost, manufacturing and/or other characteristics can be used.

One advantage of the embodiment of the pallet 100 described above is that the core 275 does not absorb water. As a result, water will not be absorbed into the structural panel 160 if the facesheets 225 are punctured. This can reduce the risk of facesheet delamination and increase the service life of the pallet as compared to conventional air cargo pallets having, for example, balsa wood cores.

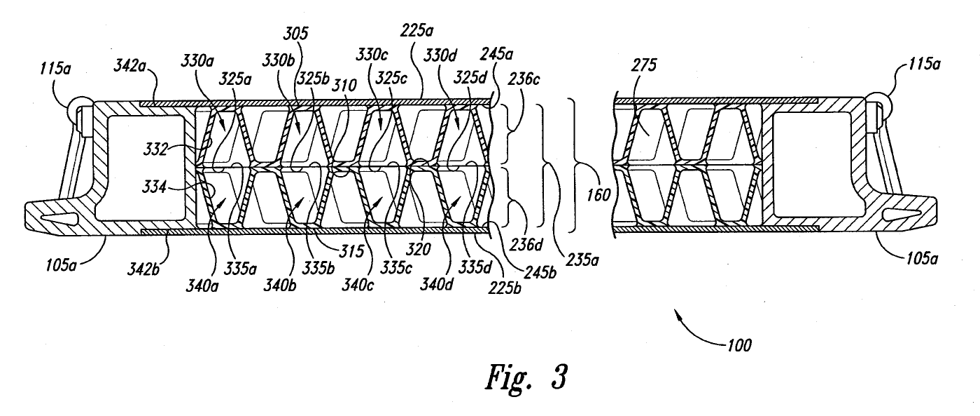

FIG. 3 is an enlarged, cross-sectional side view of the pallet 100 taken along line 3-3 in FIG. 1 illustrating various features of the core 275 in more detail. As this view illustrates, the third piece of expanded polymeric material 236c has a first surface 305 opposite a second surface 310. The first surface 305 is attached to the first facesheet 225a by the adhesive 245a. The fourth piece of expanded polymeric material 236d has a third surface 320 opposite a fourth surface 315. The third surface 320 is attached to the second surface 310 by the adhesive 265a, and the fourth surface 315 is attached to the second facesheet 225b by the adhesive 245b.

In another aspect of this embodiment, the first and second pieces of expanded polymeric material 236 can have cavities that form honeycomb-like structures in the first and second pieces of expanded polymeric material 236. For example, the third piece of expanded polymeric material 236c has a plurality of first cavities 330 (identified individually as first cavities 330a-d) which define a plurality of corresponding first openings 325 (identified individually as first openings 325a-d) in the second surface 310. Similarly, the fourth piece of expanded polymeric material 236d has a plurality of second cavities 340 (identified individually as second cavities 340a-d) which define a plurality of corresponding second openings 335 (identified individually as second openings 335a-d) in the third surface 320. Each of the first cavities 330 can have a sidewall 332 which tapers inwardly as it extends away from the corresponding opening 325 toward the first surface 305. Each of the second cavities 340 can have a sidewall 334 which also tapers inwardly as it extends away from the corresponding opening 335 toward the fourth surface 315. In the embodiment depicted in FIG. 3, each of the first openings 325 in the third piece of expanded polymeric material 236c is generally aligned with a corresponding second opening 335 in the fourth piece of expanded polymeric material 236d, such that each of the first cavities 330 is at least generally aligned with a corresponding second cavity 340.

One advantage of aligning the openings 325 and 335 in the foregoing manner is that it can increase the strength and stiffness of the core 275 over a more random assembly. As a result, the pallet 100 can meet or exceed the strength and performance characteristics of commercial pallets having balsa wood cores, while being lighter and more durable.

The first facesheet 225a and the second facesheet 225b can be attached to the rails 105a by adhesive 342 (shown as a first portion of adhesive 342a and a second portion of adhesive 342b). The adhesive 3423 can include, for example, Lord® 406 acrylic adhesive or other adhesives having suitable bonding characteristics. Additionally or alternatively, the first and second facesheets 225 can be attached to the rails 105 by fasteners (e.g., rivets) welding, brazing, and/or other suitable fastening techniques known in the art.

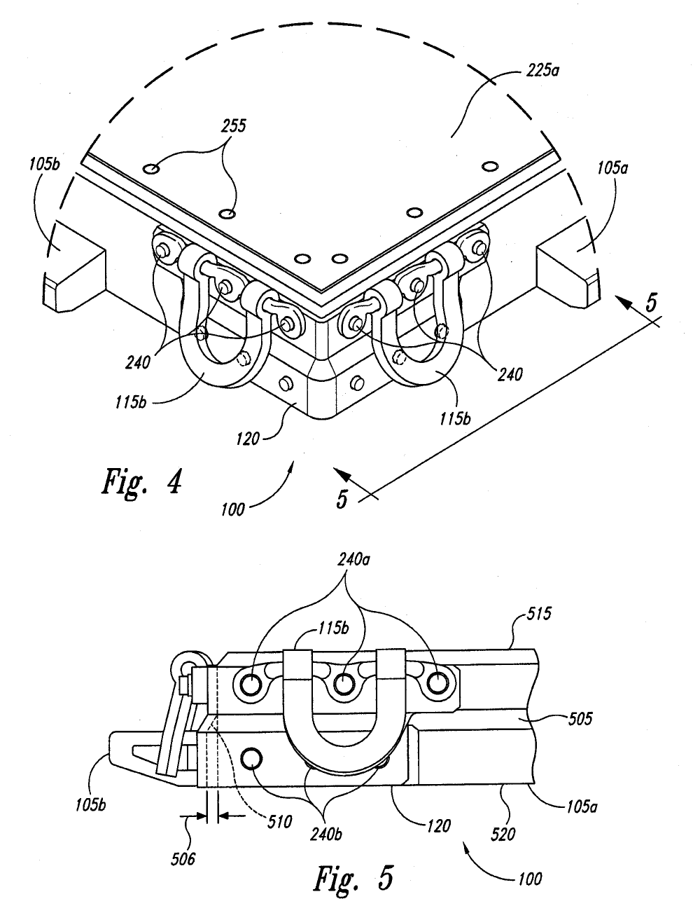

FIG. 4 is an enlarged isometric top view of a corner portion of the pallet 100 of FIG. 1. In addition to, or as an alternative to, bonding, the facesheets 225 can be attached to the rails 105 by a plurality of fasteners, such as rivets, e.g., blind rivets 255. Additional fasteners, such as rivets 240 can be used to attach the securing features 115b to the corner bracket 120 and to the rails 105. Bolts, screws or other suitable fasteners known in the art can be used in place of the rivets 255 and 240. The securing features 115 can include D-rings, clips, cleats, and/or other attachment features to which nets or other cargo restraint devices can be secured.

FIG. 5 is an enlarged side view of the corner portion shown in FIG. 4, taken along line 5-5 in FIG. 4. The rails 105 have an exterior surface 505 with an offset or step 506. The corner bracket 120 has an inner surface 510 that is contoured to match the rail offset 506, such that the corner bracket 120 sits snugly against the rails 105. A plurality of rivets or other suitable fasteners 240 fixedly attach the corner bracket 120 to the rail 105a. The fasteners 240a extend through the securing feature 115b, the corner bracket 120, and the rail 105a, and also attach the securing feature 115b to the rail 105a, while the fasteners 240b extend through just the corner bracket 120 and the rail 105a. The corner bracket 120 extends from substantially the top 515 to substantially the bottom 520 of the rails 105.

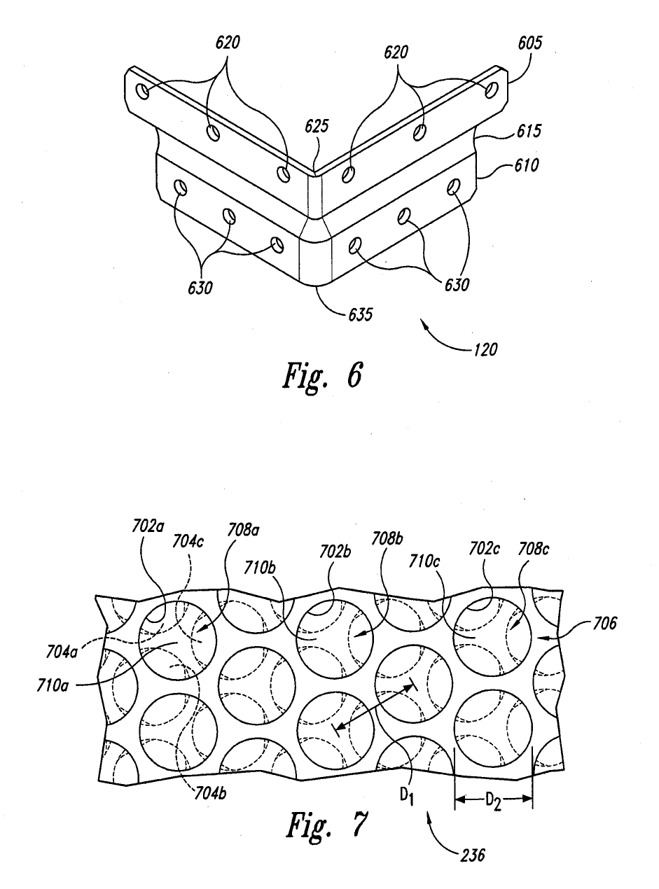

FIG. 6 is an enlarged isometric view of the corner bracket 120 of FIG. 5. The corner bracket 120 includes a transition surface 615 connecting a first flange portion 605 to a second flange portion 610. The second flange portion 610 is offset from the first flange portion 605 to accommodate the offset in the rails 105 discussed above with reference to FIG. 5. On either side of a bend 635, the second flange portion 610 has three holes 630 through which rivets or other fasteners can be installed to fixedly attach the second flange portion 610 to the rail 105. On either side of the bend 625, the first flange portion 605 has three holes 620 through which rivets or other fasteners can be installed to fixedly attach the first flange portion 605 to the rail 105. The rivets or other fasteners that extend through the holes 620 can also mount the securing features 115b (FIG. 5) to the first flange portion 605 and the rail 105.

In one embodiment, the corner bracket 120 can be made from heat-treated 4130 steel that has a thickness of from about 0.10 inch thick to about 0.50 inch, e.g., about 0.125 inch thick. In other embodiments, however, the corner bracket 120 can be made from other material, having suitable weight, strength, cost, manufacturing, and/or other characteristics.

Air cargo pallets can be subjected to various forces during use that can weaken the structural integrity of the pallets. For example, air cargo pallets can be subject to bending or twisting leads that stress the corners of the pallets. This can weaken the core-to-facesheet bonds in the pallet. This can also weaken the adhesive bonds and/or rivets between the facesheets and the edge rails. One advantage of the corner bracket 120 illustrated in FIG. 6 is that because it is contoured to match the contour of the rails, and because it extends substantially from the top of the rails to the bottom of the rails, it can resist bending and twisting forces that could otherwise weaken the structural integrity of the air cargo pallet to which it is mounted. Another advantage is that by mounting the securing features directly to the corner bracket 120, forces exerted upon the securing features can be more evenly distributed around the corner of the air cargo pallet. This can result in less stress to the adhesive bonds between the facesheets and the core, and less stress to the adhesive bonds and/or rivets between the facesheets and the rails. Accordingly, corner brackets 120 configured as illustrated in FIG. 6 can lengthen the service life of the air cargo pallets.

FIG. 7 is an enlarged top view of a portion of the expanded polymeric material 236 described above with reference to FIGS. 2 and 3. The expanded polymeric material 236 has a surface 706 with a plurality of generally circular openings 702 (identified individually as openings 702a, 702b and 702c). Each of the openings 702 is adjacent to a corresponding cavity 708 (identified individually as 708a, 708b and 708c). In the illustrated embodiment, each of the cavities 708 has a plurality of sidewall portions 704. In cavity 708a, for example, these sidewall portions are identified individually as sidewall portions 704a-c. The sidewall portions 704 taper inwardly from the corresponding opening 702 to a central or intermediate portion 710 (identified individually as intermediate portions 710a-c) of the expanded polymeric material 236. For example, the opening 702a opens to the cavity 708a. Cavity 708a is formed by three sidewall portions 704a, 704b and 704c. The three sidewall portions 704a, 704b and 704c converge inwardly from the opening 702a in a generally triangular fashion to the central or intermediate portion 710a.

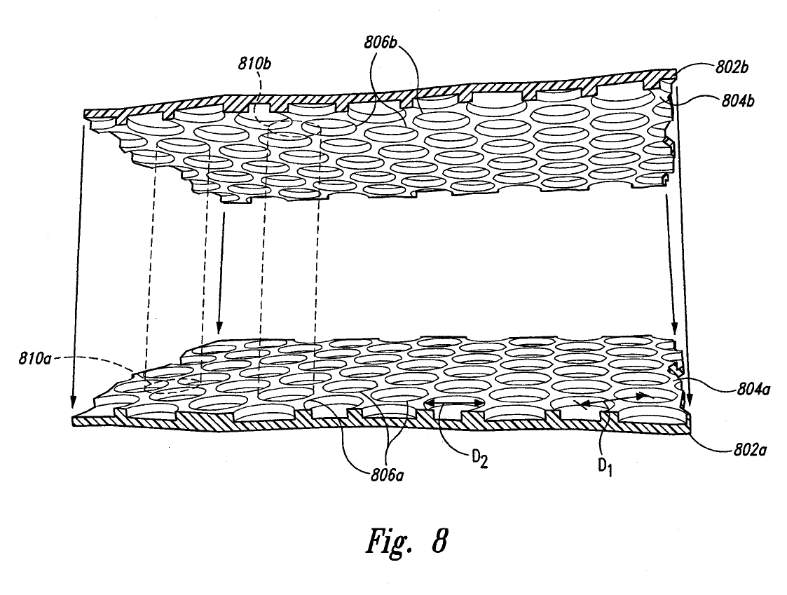

In one aspect of this embodiment, the centers of the openings 702 are spaced apart from each other by a distance D1, which can be from about 0.75 inch to about 1.5 inches, e.g., about 1.0 inch, and each of the openings 702 can have a diameter D2 of from about 0.5 inch to about 1.5 inches, e.g., about 0.75 inch. As discussed in greater detail below with reference to FIG. 8, this particular configuration of generally circular openings 702 and generally triangular cavities 708 is determined by the configuration of the platens used to manufacture the expanded polymeric material 236. However, a multitude of other configurations are possible. For example, other configurations can have openings that are polygonal with fewer or more than three sidewall portions, or with circular or conical sidewall portions, or with sidewall portions that do not converge. In other configurations, the generally circular openings 702 can have different diameters or can be spaced apart from each other by different offset distances. Accordingly, those of skill in the art will appreciate that the present invention is not limited to the particular embodiment of expanded polymeric material 236 described above.

FIG. 8 is an isometric view of first platen 802a and a second platen 802b that can be used to manufacture the expanded polymeric material 236 described above with reference to, e.g., FIG. 7. The first platen 802a has an array of first recesses 806a in a first face 804a. Similarly, the second platen 802b has an array of second recesses 806b in a second face 804b. In the illustrated embodiment, the recesses 806 are at least approximately circular. In other embodiments, however, the recesses 806 can have other shapes.

When the platens 802 are closed, the second recesses 806b are offset from the first recesses 806a as shown by the region 810a, which partially overlaps several of the first recesses 806a on the first face 804a of the first platen 802a. Similarly, the second region 810b partially overlaps several of the second recesses 806b on the second face 806b of the second platen 802b.

In one aspect of this embodiment, the recesses 806 extend inwardly to a depth of from about 0.1 inch to about 1.5 inches, e.g., about 0.25 inch from the surfaces 804, thus forming cylindrical cavities in the respective platens 802. The centers of the recesses 806 are spaced apart from each other by the distance D1 shown in FIG. 7. Similarly, each of the recesses 806 has the diameter D2 shown in FIG. 7.

The configuration of the recesses 806 in the platens 802 results in the generally circular openings, cavities, and tapering sidewall portions of the expanded polymeric material 236 described above with reference to FIG. 7. Those of skill in the art will understand, however, that other core configurations are possible, such as where the recesses 806 are polygonal, arranged in different patterns, have centers that are spaced apart from each other by different distances, and/or have different diameters.

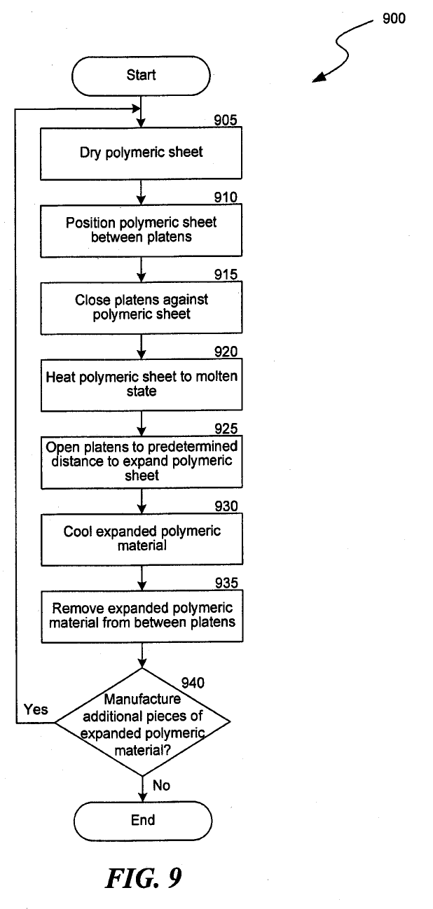

In one aspect of this embodiment, one or both of the first and second platens 802 can be slightly concave. This concavity is to compensate for any expansion of the first and second platens 802 that might occur when they are heated during the polymeric material expansion process, described in more detail below with reference to FIG. 9.

FIG. 9 illustrates a process flow 900 for forming expanded polymeric material, such as the expanded polymeric material 236 described above, in accordance with an embodiment of the invention. In block 905, a sheet of raw polymeric material is dried. The polymeric sheet can include Lexan® polycarbonate, and/or other suitable polycarbonate, polymeric, or synthetic materials known in the art. In one embodiment, the polymeric sheet has a thickness of from about 0.10 inch to about, 1.00 inch, e.g., about 0.18 inch, a width of from 50 inches to about 70 inches, e.g., about 60 inches, and a length of from about 100 inches to about 150 inches, e.g., about 120 inches. In other embodiments, sheets having other dimensions can be used. The polymeric sheet can be dried in an oven at approximately 250 degrees Fahrenheit for a period of time lasting from about 4 hours to about 16 hours, e.g., about 12 hours, to remove moisture. If the moisture is not removed, it can cause undesired deformities when the polymeric sheet is subsequently expanded. After drying, in block 910, the polymeric sheet is placed on the surface of a forming platen, such as the first platen 802a of FIG. 8.

In block 915, the first and second platens 802 are brought together until the second platen 802b contacts the polymeric sheet. The first and second platens 802 can have multiple circular recesses as detailed in the description corresponding to FIG. 8. At this point in the process, the first and second platens 802 are at room temperature. In block 920, the polymeric sheet is heated to a molten state by raising the temperature of the first and second platens 802 to, e.g., a temperature of from about 390 degrees Fahrenheit to about 450 degrees Fahrenheit, e.g., about 420 degrees Fahrenheit. The softness of the polymeric sheet can be tested by poking or prodding the polymeric sheet. The polymeric sheet softens to the point that the polymeric material becomes molten, or flowable, and adheres to the first and second platens 802. That is, the polymeric sheet adheres to the surface regions on the faces 804 of the platens 802 where there are no circular recesses 806 (see FIG. 8).

In block 925, the platens 802 are moved apart a preset distance to expand the polymeric sheet. More specifically, the polymeric sheet is expanded, or pulled, by moving the second platen 802b away from the first platen 802a while the flowable polymeric material adheres to the platens 802. The polymeric material is expanded to a predetermined thickness beyond its final thickness prior to assembly in the pallet. This is done to allow for surfacing of the expanded material to provide a suitably flat and controlled surface for bonding. For example, in an embodiment of the invention, the expanded polymeric material can be pulled to a thickness of 1.06 inches and then surfaced down to a final thickness of about 1.00 inch. In other embodiments, the expanded polymeric material can have other thicknesses from, for example, about 0.5 inch to about 3.0 inches.

In block 930, the expanded polymeric material is allowed to cool. Once the expanded polymeric material has cooled to a temperature from about 65 degrees Fahrenheit to about 70 degrees Fahrenheit, e.g., about 65 degrees Fahrenheit, the first and second platens 802 are separated. In block 935, the expanded polymeric material is removed from between the platens 802. In decision block 940, it is determined if additional pieces of expanded polymeric material are presently needed. If so, the process returns to block 905. If not, the process 900 ends.

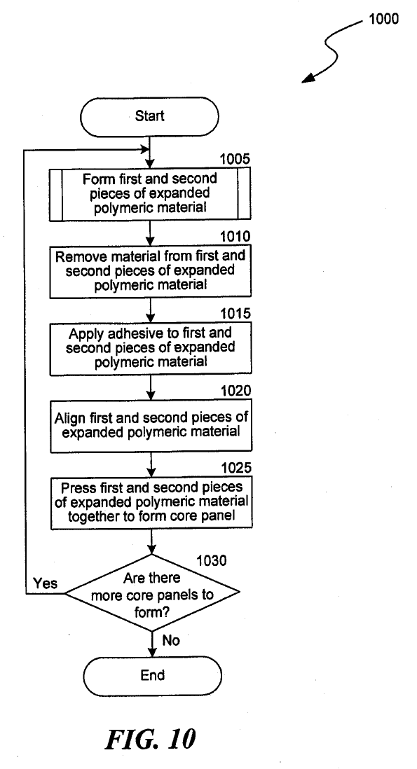

FIG. 10 illustrates a process flow 1000 for forming a core panel, such as the core panels 235 of FIG. 2, in accordance with an embodiment of the invention. In block 1005, two pieces of expanded polymeric material have been formed according to the process described above with reference to FIG. 9. In block 1010, the first and second pieces may be sanded, planed, or otherwise surfaced to remove material, level the surfaces, and/or provide suitable surfaces for bonding. The first and second pieces may also be trimmed using a core trimmer to a specified length and/or width. In one embodiment, for example, the first and second pieces can be trimmed to a width of from about 75 inches to about 85 inches, e.g., about 81 inches, and to a length of from about 45 inches to about 55 inches, e.g., about 51 inches. In other embodiments, the first and second pieces of expanded polymeric material may be glued together first and then trimmed to a specified length and/or width.

At this point in the process 1000, the first and second pieces of expanded polymeric material are configured as illustrated in FIG. 7. In block 1015, adhesive is applied to the first and second pieces. In one embodiment, the adhesive can be applied using a hot melt adhesive applicator, which applies adhesive to the first and second pieces with a drum roller. In other embodiments, adhesive can be manually applied. In block 1020, the openings in the first piece of expanded polymeric material are at least approximately aligned with the openings in the second piece of expanded polymeric material. In block 1025, the first piece is pressed against the second piece with the openings generally aligned, and the adhesive cures, to form a core panel. In decision block 1030, it is determined whether to form additional core panels. If so, the process 1000 returns to block 1005. If not, the process 1000 ends.

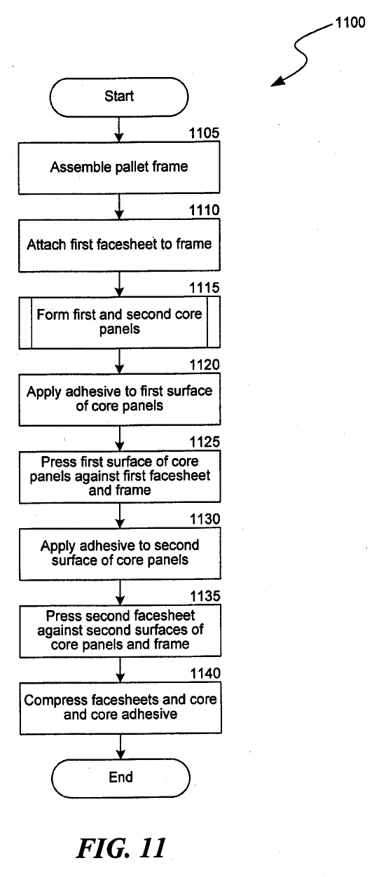

FIG. 11 illustrates a process flow 1100 for manufacturing an air cargo pallet in accordance with an embodiment of the invention. For purposes of illustration, the process flow 1100 is described below in the context of the pallet 100 described above with reference to FIGS. 1-3. In other embodiments, however, the process 1100 can be used for other types of air cargo pallets.

In block 1105, a pallet frame is assembled from the rails 1 05 and the corner brackets 120. The securing features 115 can also be attached to the rails 105 at this time. In block 1110, the first facesheet 225a is attached to the frame. The first facesheet 225a is attached to the frame with adhesive applied to the matching surfaces of the frame. Alternatively or additionally, adhesive can also be applied to the surfaces of the first facesheet 225a. The first facesheet 225a can also be riveted to the frame at this time.

In block 1115, two core panels 235 have been formed according to the process described above with reference to FIG. 10. In block 1120, adhesive is applied to a first surface of the two core panels 235 using a hot melt adhesive applicator, or by manual application. Adhesive can also be applied to the side faces of the two core panels 235 to attach the two core panels 235 to the frame and to each other. Alternatively or additionally, adhesive can also be applied to the inner faces of the frame. In block 1125, the two core panels 235 are positioned on the first facesheet 225a and the frame. The two core panels 235 can be positioned by manually placing them in the proper position, or by lowering them into the proper position with a lift, hoist or other mechanism. At a block 1130 adhesive is applied to a second surface of the two core panels 235, again using a hot melt adhesive applicator or by manual application. In one embodiment, as an alternative to applying adhesive to the first surface of the two core panels 235 in block 1120 and to the second surface of the two core panels 235 in block 1130, adhesive can be applied simultaneously or nearly simultaneously to both the first and second surfaces of the two core panels 235.

At a block 1135 the second facesheet 225b is positioned on the second surface of the two core panels 235 and the frame. The second facesheet 225b can be positioned by manually placing it in the proper position, or by lowering it into the proper position with a lift, hoist or other mechanism. The second facesheet 225b can also be riveted to the frame at this time. At a block 1140 the facesheets 225 and the core 275 are compressed while the adhesive cures. This can be done by weighting one of the facesheets 225 or by applying a heavy roller to one or both of the facesheets 225.

Those of skill in the art will understand that certain steps in the processes 900, 1000, and 1100 can be performed simultaneously, in parallel and/or sequentially. For example, multiple polymeric sheets may be dried simultaneously in step 905 of the process 900. As a further example, adhesive may be applied to both the first and second surfaces of the first and second core panels in the process 1100. Those of skill in the art will also understand that additional modifications can be made to the processes 900, 1000, and 1100 without departing from the spirit and scope of the invention.

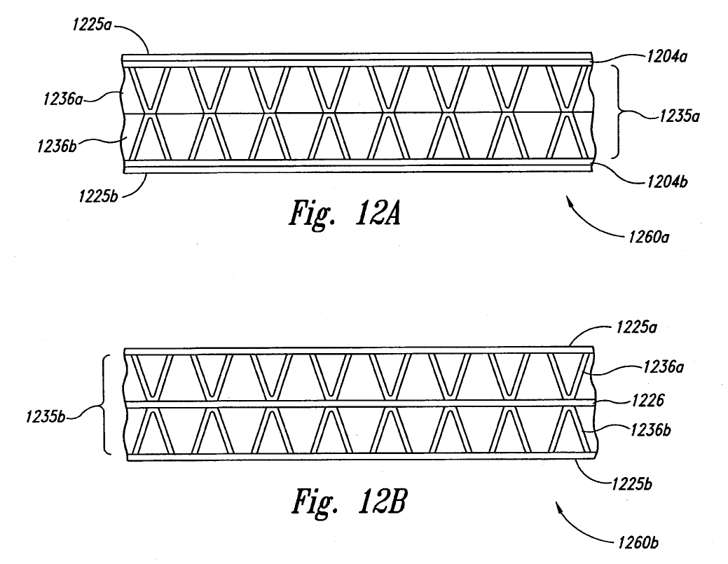

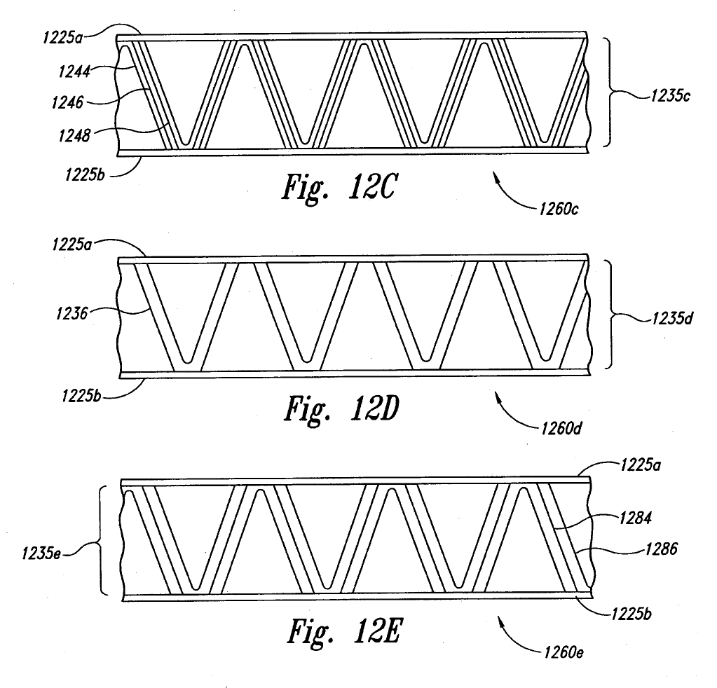

FIGS. 12A-E are cross-sectional side views of air cargo pallet structural panels 1260a-c configured in accordance with further embodiments of the invention. Referring first to FIG. 12A, the structural panel 1260a can be generally similar in structure and function to the structural panel 160 described above with reference to FIGS. 1-3. For example, the structural panel 1260a can include a core panel 1235a that includes a first piece of expanded polymeric material 1236a bonded to a second piece of expanded polymeric material 1236b. Furthermore, the core panel 1235a can be sandwiched between opposing facesheets 1225a and 1225b. In one aspect of this particular embodiment, however, the structural panel 1260a can further include a first polymer sheet 1204a and a second polymer sheet 1204b that lie between the core panel 1235a and the first and second facesheets 1225, respectively. The polymer sheets 1204 can include Lexan® polycarbonate, or other suitable polycarbonate, polymeric, synthetic, metallic, and/or non-metallic materials known in the art. The polymer sheets 1204 may increase the rigidity of the structural panel 1260a.

The structural panel 1260b of FIG. 12B can include a core panel 1235b sandwiched between a first facesheet 1225a and a second facesheet 1225b. In this embodiment, the core panel 1235b can include an intermediate sheet 1226 positioned between a first piece of expanded polymeric material 1236a and a second piece of expanded polymeric material 1236b. The intermediate sheet 1226 can be formed of various materials, such as aluminum sheet, woven aluminum, or aluminum alloy mesh. The intermediate sheet 1226 can also be formed of a fiberglass sheet or a sheet of fiberglass mesh, or other materials with suitable strength and performance characteristics known to those of skill in the art, including polymeric and polycarbonate sheets. The core panel 1235b can include the intermediate sheet 1226 for various reasons, such as to increase the rigidity of the core panel 1235b and thus the rigidity of the structural panel 1260b.

The structural panel 1260c of FIG. 12C can include a core panel 1235c sandwiched between a first facesheet 1225a and a second facesheet 1225b. In this embodiment, the core panel 1235c can be formed of a first polymeric sheet 1244, an intermediate sheet 1246, and a second polymeric sheet 1248. The intermediate sheet 1246 can be formed of various materials, such as aluminum or aluminum alloy woven aluminum, or aluminum mesh. The intermediate sheet 1246 can also be formed of fiberglass mesh, or other materials with suitable strength and performance characteristics known to those of skill in the art, including polymeric and polycarbonate sheets. These three sheets can be formed into a core panel 1235c according to the processes described above with respect to FIGS. 9-10.

The structural panel 1260d of FIG. 12D can include a core panel 1235d sandwiched between a first facesheet 1225a and a second facesheet 1225b. In this embodiment, the core panel 1235d can be formed of a single piece of expanded polymeric material 1236. The core panel 1235d can be formed according to the processes described above with respect to FIGS. 9-10.

The structural panel 1260e of FIG. 12E can include a core panel 1235e sandwiched between a first facesheet 1225a and a second facesheet 1225b. In this embodiment, the core panel 1235e can be formed of a first polymeric sheet 1284 and a second polymeric sheet 1286. These two sheets can be formed into a core panel 1235e according to the processes described with respect to FIGS. 9-10.

For the structural panels 1260 depicted in FIGS. 12A-E, any suitable adhesive known in the art for bonding polymeric, synthetic, metallic and/or non-metallic materials can be used to attach adjacent components.

From the foregoing, it will be appreciated that specific embodiments of the invention have been described herein for purposes of illustration, but that various modifications may be made without deviating from the spirit or scope of the various embodiments of the invention. For example, in some embodiments, the core of an air cargo pallet may include more than two core layers or less than two core layers. Aspects of the disclosure described in the context of particular embodiments may be combined or eliminated in other embodiments. For example, a core layer may have openings in only one surface instead of both surfaces. Further, while advantages associated with certain embodiments of the invention have been described in the context of those embodiments, other embodiments may also exhibit such advantages, and not all embodiments need necessarily exhibit such advantages to fall within the scope of the invention. Accordingly, the invention is not limited, except as by the appended claims.

I/We claim:

1. An air cargo pallet comprising:
a structural panel having a cargo support surface extending between opposing edge portions, wherein the structural panel includes:
a first piece of polymeric material having a first surface spaced apart from a second surface;
a second piece of polymeric material having a third surface spaced apart from a fourth surface, wherein the third surface of the second piece of polymeric material is attached to the second surface of the first piece of polymeric material;
a first facesheet attached to the first surface of the first piece of polymeric material and defining at least a portion of the cargo support surface; and
a second facesheet attached to the fourth surface of the second piece of polymeric material; and
a plurality of edge members fixedly attached to corresponding edge portions of the structural panel.

2. The air cargo pallet of claim 1:
wherein the first piece of polymeric material has a plurality of first openings in the second surface and a plurality of first cavities extending inwardly from the plurality of first openings;
wherein the second piece of polymeric material has a plurality of second openings in the third surface and a plurality of second cavities extending inwardly from the plurality of second openings; and
wherein the plurality of first openings is at least approximately aligned with the plurality of second openings.

3. The air cargo pallet of claim 2 wherein each of the first and second cavities includes a converging sidewall.

4. The air cargo pallet of claim 1 wherein the second surface of the first piece of polymeric material is adhesively bonded to the third surface of the second piece of polymeric material.

5. The air cargo pallet of claim 1 wherein each of the first and second pieces of polymeric material has a thickness of from about 0.5 inch to about 1.5 inches.

6. The air cargo pallet of claim 1 wherein the first facesheet is adhesively bonded to the first surface of the first piece of polymeric material and the second facesheet is adhesively bonded to the fourth surface of the second piece of polymeric material.

7. The air cargo pallet of claim 1, further comprising a plurality of cargo securing features fixedly attached to the edge members.

8. The air cargo pallet of claim 1:
wherein the first piece of polymeric material includes:
a plurality of first cavities extending inwardly from the first surface; and
a plurality of second cavities extending inwardly from the second surface;
wherein the second piece of polymeric material includes:
a plurality of third cavities extending inwardly from the third surface; and
a plurality of fourth cavities extending inwardly from the fourth surface; and
wherein the plurality of second cavities in the second surface is generally aligned with the plurality of third cavities in the third surface.

9. The air cargo pallet of claim 1 wherein each of the edge members has an exterior contour, and wherein the air cargo pallet further comprises a plurality of corner brackets that each have an interior contour that at least approximately matches the exterior contour of the edge members.

10. The air cargo pallet of claim 1 wherein the structural panel further includes:
a third piece of polymeric material having a fifth surface spaced apart from a sixth surface, wherein the fifth surface is attached to the first facesheet; and
a fourth piece of polymeric material having a seventh surface spaced apart from an eighth surface, wherein the eighth surface is attached to the second facesheet and the seventh surface is attached to the sixth surface of the third piece of polymeric material.

11. The air cargo pallet of claim 1 wherein the first and second first pieces of polymeric material include expanded polycarbonate material.

12. The air cargo pallet of claim 1 wherein the first and second facesheets include metallic material.

13. An air cargo pallet comprising:
a structural panel having a cargo support surface, wherein the structural panel includes:
a polymeric core having a first core surface opposite a second core surface;
a first facesheet positioned toward the first core surface, wherein the first facesheet defines at least a portion of the cargo support surface; and
a second facesheet positioned toward the second core surface.

14. The air cargo pallet of claim 13 wherein the polymeric core includes:
a first core layer;
a second core layer; and
an adhesive layer bonding the first core layer to the second core layer.

15. The air cargo pallet of claim 14 wherein the first core layer includes first and second polymeric portions and the second core layer includes third and fourth polymeric portions.

16. The air cargo pallet of claim 14:
wherein the first core layer has a plurality of first cavities extending inwardly from corresponding first openings;
wherein the second core layer has a plurality of second cavities extending inwardly from corresponding second openings; and
wherein the plurality of first openings is at least approximately aligned with the plurality of second openings.

17. The air cargo pallet of claim 16 wherein each of the cavities includes a converging sidewall.

18. The air cargo pallet of claim 14 wherein each of the first and second core layers has a thickness of from about 0.5 inch to about 1.5 inches.

19. The air cargo pallet of claim 13 wherein the first facesheet is adhesively bonded to the first surface of the polymeric core and the second facesheet is adhesively bonded to the second surface of the polymeric core.

20. The air cargo pallet of claim 13 wherein the polymeric core includes expanded polycarbonate material.

21. A method of manufacturing an air cargo pallet, the method comprising:
providing a frame;
attaching a first facesheet at least proximate to the frame;
heating a polymeric sheet having a first thickness;
expanding the heated polymeric sheet to a second thickness greater than the first thickness to form a piece of expanded polymeric material;
positioning the first facesheet toward a first side of the piece of expanded polymeric material; and
positioning a second facesheet toward a second side of the piece of expanded polymeric material; and
attaching the second facesheet at least proximate to the frame.

22. The method of claim 21 wherein the polymeric sheet is a first polymeric sheet and the piece of expanded polymeric material is a first piece of expanded polymeric material, and wherein the method further comprises:
heating a second polymeric sheet having a third thickness;
expanding the heated second polymeric sheet to a fourth thickness greater than the third thickness to form a second piece of expanded polymeric material;
positioning a third side of the second piece of expanded polymeric material toward the second side of the first piece of expanded polymeric material; and
positioning the second facesheet toward a fourth side of the second piece of expanded polymeric material.

23. The method of claim 22 further comprising adhesively bonding the third side of the second piece of expanded polymeric material to the second side of the first piece of expanded polymeric material.

24. The method of claim 22 wherein expanding the heated first and second polymeric sheets includes:
forming a plurality of cavities in the second side of the first piece of expanded polymeric material; and
forming a plurality of cavities in the third side of the second piece of expanded polymeric material.

25. The method of claim 24, further comprising attaching the second side of the first piece of expanded polymeric material to the third side of the second piece of expanded polymeric material.

26. The method of claim 25 wherein attaching the second side of the first piece of expanded polymeric material to the third side of the second piece of expanded polymeric material includes:
generally aligning the cavities in the second side of the first piece of expanded polymeric material with the cavities in the third side of the second piece of expanded polymeric material; and
adhesively bonding the second side of the first piece of expanded polymeric material to the third side of the second piece of expanded polymeric material.

27. The method of claim 21 wherein heating the polymeric sheet includes heating the polymeric sheet between two platens.

28. The method of claim 21, further comprising trimming the piece of expanded polymeric material.

29. The method of claim 28 wherein trimming the piece of expanded polymeric material includes trimming the piece of expanded polymeric material to a width of from about 75 inches to about 85 inches and to a length of from about 45 inches to about 55 inches.

30. The method of claim 21 wherein the polymeric sheet includes polycarbonate.

31. A method of manufacturing an air cargo pallet, the method comprising:
heating a first polymeric sheet;
expanding the heated first polymeric sheet to form a first piece of expanded polymeric material;
heating a second polymeric sheet;
expanding the heated second polymeric sheet to form a second piece of expanded polymeric material; and
bonding the first piece of expanded polymeric material to the second piece of expanded polymeric material to form a polymeric core.

32. The method of claim 31, further comprising:
positioning a first skin toward a rectangular frame;
positioning a first surface of the polymeric core toward the first skin; and
positioning a second skin toward a second surface of the polymeric core.

33. The method of claim 31 wherein heating the first and second polymeric sheets includes positioning the first and second polymeric sheets between two platens.

34. The method of claim 31 wherein expanding the heated first polymeric sheet includes forming a plurality of cavities in a first side of the first piece of expanded polymeric material and expanding the heated second polymeric sheet includes forming a plurality of cavities in a second side of the second piece of expanded polymeric material.

35. The method of claim 34 wherein bonding the first piece of expanded polymeric material to the second piece of expanded polymeric material includes at least approximately aligning the cavities in the first side of the first piece of expanded polymeric material with the cavities in the second side of the second piece of expanded polymeric material.

36. The method of claim 34 wherein each of the cavities includes a converging sidewall.

37. The method of claim 31, further comprising trimming the first and second pieces of expanded polymeric material to a width of from about 75 inches to about 85 inches and to a length of from about 45 inches to about 55 inches.

38. The method of claim 31 wherein the first and second polymeric sheets include polycarbonate.

39. A system for manufacturing an air cargo pallet, the system comprising:
means for expanding a polymeric sheet to form a piece of expanded polymeric material;
means for positioning a first surface of the piece of expanded polymeric material toward a frame and a first facesheet; and
means for positioning a second facesheet toward a second surface of the piece of expanded polymeric material.

40. The system of claim 39, further comprising means for heating the polymeric sheet.

41. The system of claim 39, further comprising means for removing material from the piece of expanded polymeric material.

42. The system of claim 39, further comprising means for drying the polymeric sheet.
